(19) United States
(12) Patent Application Publication
(10) Pub. No.: US 2009/0228628 A1
(43) Pub. Date: Sep. 10, 2009

(54) MULTI-FPGA PCI EXPRESS X16 ARCHITECTURE

(75) Inventor: Matthew R. Standfield, Dallas, TX (US)

Correspondence Address: HOVEY WILLIAMS LLP, 10801 Mastin Blvd., Suite 1000, Overland Park, KS, 66210, US

(73) Assignee: L3 Communications Integrated Systems, L.P., Greenville, TX (US)

(21) Appl. No.: 12/043,639

(22) Filed: Mar. 6, 2008

(51) Int. Cl. G06F 3/00

(52) U.S. Cl. 710/316

(57) ABSTRACT

An architecture for providing data communication between a plurality of field-programmable gate arrays (FPGAS) and a multi-channel data bus comprises a plurality of FPGAs, a switching element, and a multi-channel data bus. Each FPGA includes a multi-channel endpoint component to enable communication with at least a portion of the multi-channel data bus. The switching element couples each FPGA endpoint component with the multi-channel data bus, allowing communication between the FPGA endpoint components and the data bus such that every channel of the data bus is coupled to a channel of an FPGA endpoint component.

### BACKGROUND OF THE INVENTION

1. Field of the Invention

Embodiments of the present invention relate to communication architectures for field-programmable gate arrays (FPGAs). More particularly, embodiments of the present invention relate to communication architectures that include a plurality of FPGAs and a multi-channel data bus, which allow each FPGA to access a portion of the bits of the multi-channel data bus.

2. Description of the Related Art

FPGAs often include endpoint components that enable access to a multi-channel data bus. However, there may be limitations of the endpoint components or incompatibility between the endpoint components and the multi-channel data bus that prevent optimum utilization of the multi-channel data bus.

### SUMMARY OF THE INVENTION

Embodiments of the present invention solve the above-mentioned problems and provide a distinct advance in the art of communication architectures for FPGAs. More particularly, embodiments of the invention provide a communication architecture that includes a plurality of FPGAs and a multi-channel data bus, which allows each FPGA to access a portion of the bits of the multi-channel data bus.

The communication architecture includes a plurality of FPGAs, a switching element, and a multi-channel data bus. Each FPGA includes a multi-channel endpoint component to enable communication with at least a portion of the multi-channel data bus. The switching element couples each FPGA endpoint component with the multi-channel data bus, allowing communication between the FPGA endpoint components and the data bus such that every channel of the data bus is coupled to a channel of an FPGA endpoint component.

The architecture allows an application, such as for digital signal processing (DSP) or high-performance computing, to be partitioned among multiple FPGAs and communicate with other devices, such as memory, processing elements, or displays, while utilizing the full bandwidth available through the multi-channel bus.

This summary is provided to introduce a selection of concepts in a simplified form that are further described below in the detailed description. This summary is not intended to identify key features or essential features of the claimed subject matter, nor is it intended to be used to limit the scope of the claimed subject matter.

Other aspects and advantages of the present invention will be apparent from the following detailed description of the preferred embodiments and the accompanying drawing figures.

### BRIEF DESCRIPTION OF THE DRAWING FIGURES

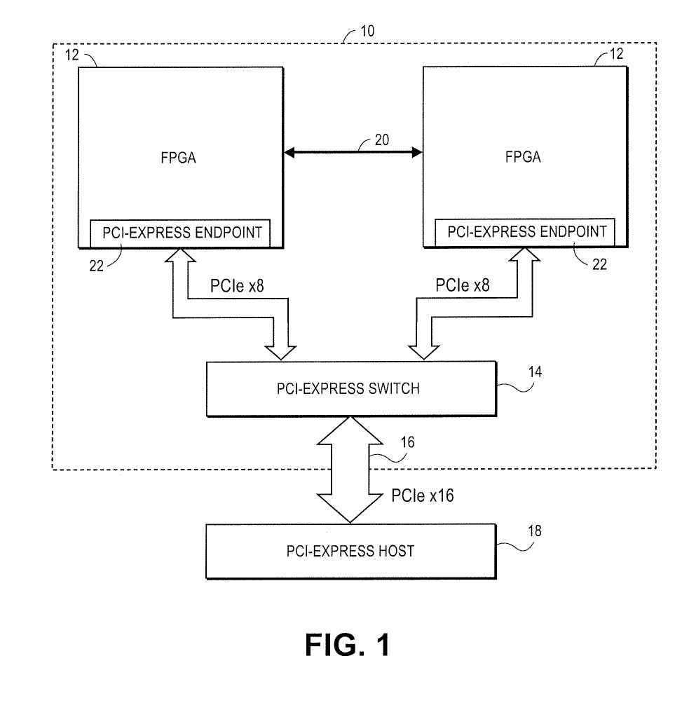

A preferred embodiment of the present invention is described in detail below with reference to the attached drawing FIG. 1, which is a block diagram of a communication architecture for FPGAs constructed in accordance with various embodiments of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

A communication architecture 10 for field-programmable gate arrays (FPGAs), constructed in accordance with various embodiments of the present invention, is shown in FIG. 1. The architecture 10 comprises a plurality of FPGAs 12, a switching element 14, and a multi-channel data bus 16. The multi-channel data bus 16 may also couple with an external host 18 that monitors communication between devices connected to the multi-channel data bus 16.

The FPGA 12 generally is programmed to execute a portion of an application, wherein the application may involve digital signal processing (DSP) or high-performance computing applications, such as discrete or fast Fourier transforms (FFTs), finite-impulse response (FIR) filtering, solving systems of linear equations, and the like. The application may be partitioned among a plurality of processing elements, operating either in parallel or serial fashion, that are programmed in a plurality of FPGAs 12. There may also be a communication path 20 between the FPGAs in order to transfer data or control and timing signals during the execution of an application. In such an embodiment, the application may utilize the full bandwidth of the multi-channel data bus 16 to communicate with other devices connected to the bus 16.

In other embodiments, each FPGA 12 may execute a single application or a plurality of applications such that each application has access to only a portion of the multi-channel data bus.

In various embodiments, the FPGA 12 includes an endpoint component 22, which allows one or more of the applications running on the FPGA to communicate with at least a portion of the multi-channel data bus 16. The endpoint component 22 may include various network layer protocol components as are known in the art. The endpoint component 22 may be included as a built-in block of the FPGA 12 or may be programmed into the FPGA 12 using one or more code segments of a hardware description language (HDL).

In certain embodiments, the endpoint component 22 may be a separate component, external to the FPGA 12, wherein communication is established between the FPGA 12 and the endpoint component 22 through standard FPGA I/O ports.

In various embodiments, the switching element 14 may couple the endpoint components 22 with the multi-channel data bus 16. The switching element 14 may have the capability to switch data packets. In addition, the switching element 14 may allow any channel of the data bus 16 to couple to any channel of the plurality of endpoint components 22. For example, channel 5 of the multi-channel data bus 16 may be coupled through the switching element 14 to channel 2 of a first endpoint component 22. The connection configuration of the switching element 14, i.e. which endpoint 22 channel is coupled with which data bus 16 channel, may be established either automatically by the one or more applications being executed by the one or more FPGAs 12, or manually by a user.

The switching element 14 may include various architectures or topologies such as crossbar or crossover and may be formed from analog or digital circuitry. The switching element 14 may be described as one or more code segments of a hardware description language (HDL) and may be implemented in a programmable logic device (PLD) or as a fully-custom or semi-custom application-specific integrated circuit (ASIC).

In various embodiments, the multi-channel data bus 16 is a high-bandwidth communication medium that allows one or more components to communicate with one or more other components. Generally, the multi-channel data bus 16 supports communication such as electronic data, including signal data, computational data, or text-based information, video data, voice data, audio data, and the like. Each channel of the multi-channel data bus 16 may be uni-directional, allowing data to flow in only one direction between components, or may be bi-directional, allowing data to flow in both directions between components. The multi-channel data bus 16 may be formed utilizing individual electrically conductive elements, wherein each channel may include one or more conductive elements. The data bus 16 may be implemented utilizing electrically conductive traces on a single-layer or multi-layer printed circuit board (PCB), multi-chip module (MCM), hybrid combinations thereof, and the like. The multi-channel data bus 16 may also be implemented using optical backplane or similar technology. In addition, the multi-channel data bus 16 may support various protocols and standards regarding electrical or optical characteristics, such as voltage levels and data rate or optical wavelength.

In various embodiments, the external host 18 couples the multi-channel data bus 16 with the external environment. The host 18 may act as a portal that couples the multi-channel data bus 16 with other components, such as processing elements, memory elements, display units, and printing units, or with other multi-channel data buses. The external host 18 may include processing elements, switching elements, memory elements, or combinations thereof, and may be formed from electrical or optical components.

In certain embodiments, the FPGA 12 may be a Virtex-5 from Xilinx, Inc. of San Jose, Calif. The Virtex-5 FPGA 12 may include a PCI Express x8-compatible 8-lane endpoint 22. The switching element 14 may be a PEX 8632 32-lane switch from PLX Technology, Inc. of Sunnyvale, Calif. The multi-channel data bus 16 may be a PCI Express x16 16-lane data bus protocol, developed by Intel of Santa Clara, Calif.

In various embodiments, the architecture 10 may be implemented using a first and a second Virtex-5 FPGA 12 and a PEX 8632 switching element 14 that are coupled together as shown in FIG. 1 utilizing a single-layer or multi-layer PCB. The architecture 10 may also include the communication path 20 between the FPGAs 12. Typically, the multi-channel data bus 16 may be coupled to a PCB edge connector that utilizes the PCI Express x16 form factor and protocols, as are known in the art. Thus, the architecture 10, as implemented on the PCB, may plug into another PCB, such as a motherboard in order to communicate with other components.

Various methods of utilizing the architecture 10 include the following. The user may partition an application, such as the FFT, either manually or with the assistance of computer-automated design (CAD) tools such that the application can execute on two or more FPGAs 12. To access data, the application couples with the endpoint 22 in each FPGA 12. The connection from the endpoint 22 of one FPGA 12 to the switching element 14 may include a PCI Express x8 8-lane bus. Thus, two FPGAs 12, that include the 8-lane endpoint 22 coupled with the 8-lane bus to the switching element 14, may effectively interface with the 16-lane multi-channel data bus 16, thereby allowing the application to advantage of the full bandwidth of the data bus 16. Through the multi-channel data bus 16, the application may send data to and from processing elements, memory elements, display units, and printing units.

Although the invention has been described with reference to the preferred embodiment illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A data communication architecture comprising:
a multi-channel data bus for providing high-bandwidth communication;
a plurality of field-programmable gate arrays, each field-programmable gate array including a multi-channel endpoint component for communicating with at least a portion of the multi-channel data bus; and
a switching element, coupled to each multi-channel endpoint component and the multi-channel data bus, for coupling each channel of the multi-channel data bus to a channel of a multi-channel endpoint component.

2. The data communication architecture of claim 1, wherein the multi-channel data bus is a PCI-Express x16 bus.

3. The data communication architecture of claim 1, wherein the field-programmable gate array is a Xilinx Virtex-5.

4. The data communication architecture of claim 1, wherein the switching element is a PLX technologies PEX-8632.

5. A data communication architecture comprising:
a sixteen-lane data bus for providing high-bandwidth communication;
a first field-programmable gate array, including an eight-lane endpoint component for communicating with eight lanes of the sixteen-lane data bus;
a second field-programmable gate array, including an eight-lane endpoint component for communicating with eight lanes of the sixteen-lane data bus; and
a switching element, coupled to the first field-programmable gate array, the second field-programmable gate array, and the multi-lane data bus, for allowing the eight-lane endpoint component of the first field-programmable gate array to communicate with the first eight lanes of the sixteen-lane data bus and the eight-lane endpoint component of the second field-programmable gate array to communicate with the second eight lanes of the sixteen-lane data bus.
